(19) United States
(12) Patent Application Publication
(10) Pub. No.: US 2012/0088452 A1
(43) Pub. Date: Apr. 12, 2012

(54) Method For Locating A Wirelessly Connected Device

(75) Inventor: SØREN ARNE JØRGENSEN, Ballerup (DK)

(73) Assignee: GN Netcom A/S, Ballerup (DK)

(21) Appl. No.: 13/267,030

(22) Filed: Oct. 6, 2011

Related U.S. Application Data
(60) Provisional application No. 61/391,705, filed on Oct. 11, 2010.

(51) Int. Cl. H04B 7/00

(52) U.S. Cl. 455/41.3

(57) ABSTRACT

A handheld or wearable first communication device (1; 2) for locating a second handheld or wearable communication device (1; 2). The first communication device (1) is wirelessly connected to the second device (2) and comprises a processor (6), an orientation sensor (3; 34) and a readout device (5; 20; 22). The first communication device (1; 2) is adapted to store link values representing the bit error rate of the wireless link (16) between the first communication device (1; 2) and the second communication device (1; 2) as a function of the orientation of the first communication device (1; 2). The readout device (2; 20; 22) is adapted to inform the user of the specific direction (15), at which the second communication device (1; 2) is located relative to the first communication device (1,2). The invention also relates to a method of locating a second communication device and a computer program for locating a second communication device (1; 2).

### TECHNICAL FIELD

The disclosure relates to handheld or wearable first communication device with a short-range wireless communication interface, which can establish a wireless link to a second handheld or wearable communication device with a short range wireless wireless communication interface, which first communication device comprises

a processor,
a memory for storing program code,
an orientation sensing device for sensing the orientation of the first communication device, and
a readout device for presenting information to a user,

### BACKGROUND ART

A typical device of this kind is a modern smartphone, which is an advanced mobile phone, such as an IPhone®, Motorola Droid® or HTC Desire®. These advanced devices comprise wireless transceivers so that they can be wirelessly connected to second devices, such as small headsets. The most common standard for wirelessly inter-connecting such devices is the Bluetooth® radio standard. A Bluetooth headset is often a very small device, which easily gets lost. When a Bluetooth headset or other device is wirelessly connected to a smartphone, it is normally possible to see, that this connection exists on the display on the smartphone. However, the user only knows that the headset is within range and not whether it is close to the user and in which direction, he should look for it, if it gets lost.

### SUMMARY

An object of the disclosure is to provide a new way of locating a disappeared second device, such s a headset or a mobile phone, which is wirelessly connected to a handheld or wearable communication device as described above. According to a first aspect of the disclosure, the communication device is characterized in that the first communication device is adapted to store link values representing the bit error rate of the wireless link between the first communication device and the second communication device as a function of the orientation of the first communication device, and that the first communication device via the readout device is adapted to inform the user of the specific direction, at which the second communication device is located relative to the first communication device. If a user has lost his second device, such as a Bluetooth headset, he can determine the direction to look for it in by following the steps mentioned below:

a) ensure, that there is a link between the communication device and the second device
b) hold the communication device close to a shielding object, such as his body or head
c) move around so the object shields the wireless link in different directions
d) receive info via the readout device of the direction to look for the second communication device

In most cases, the user may exercise the disclosure by starting a small application on the communication device, before he is performing the steps mentioned above. After performing these steps, the readout device of the communication device informs the user in what direction he should carry out his search for the second device.

Wikipedia.org provides the following definition of bit error rate: “In digital transmission, the number of bit errors is the number of received bits of a data stream over a communication channel that has been altered due to noise, interference, distortion or bit synchronization errors. The bit error rate or bit error ratio (BER) is the number bit errors divided by the total number of transferred bits during a studied time interval. BER is a unit less performance measure, often expressed as a percentage number.” Thus, the lower the BER is, the better the quality of the signal is.

It has proven that BER is good indicator for the quality of the wireless link between two devices. Preferably, the orientation sensing device is a solid-state compass for determining the compass direction of the first communication device. Also, the readout device is preferably an electronic display. This could be an LCD, an AMOLED display or other suitable type.

In this case, the user may locate the second communication device by following the steps mentioned below:

a) ensure, that there is a link between the communication device and the second device
b) hold the communication device close his stomach or chest
c) turn himself 360 degrees about a vertical axis
d) study the display of the communication device

According to an embodiment, the first communication device is adapted to readout information to the display showing link values in dependence of compass direction.

The communication device may be adapted to show a compass card on the display.

According to a particularly embodiment, the display is adapted to show graphical representations of link values on a compass card, such the distance between the graphical representation and the centre of the compass card indicates the link value. This solution also provides information about the differences in link values and thereby an indirect accuracy of direction at which the second communication device is located.

The link value may be determined by the second communication device and transmitted via the wireless link to the first communication device. Thus, if f. ex. the first communication device is a smartphone, and the second communication device is a headset, the headset may determine and communicate a BER-value to the smartphone.

According to an alternative embodiment, the readout device is a speaker. F. ex., the speaker can inform the user about the about the specific compass direction to look for the second communication device by a synthetic voice saying “Northeast”, or in a dynamic way “turn left, stop, look in this direction”. Alternatively, a simple sounds such as beeps, or the like could indicate at which compass direction the user should search for the second communication device.

According to an embodiment, the short-range wireless communication interface comprises a Bluetooth transceiver.

Preferably, the first communication device is a smartphone. Modern smartphones are typically provided with a solid-state compass and a large display.

The first communication device may also be a headset.

The disclosure also relates to a method for locating the direction of a second handheld or wearable communication device, by means of a hand held or wearable first communication device, which is wirelessly connected by wireless link to the second device, which first communication device comprises

a processor,
a memory for storing program code,
an orientation sensing device for sensing the orientation of the first communication device, program code for storing link values representing the bit error rate of the wireless link between the first communication device and the second communication device as a function of the direction of the first communication device,
a readout device for presenting information to a user, which method comprising the steps of
a) holding the first communication device adjacent to a signal shielding object, which shielding object partially shields the wireless signal providing the wireless link,
b) turning the first communication device and the signal shielding object in relation to each other,
c) readout information via the readout device informing a user at which direction the second communication device is located relative to the first communication device.

According to the disclosure, the orientation sensing device may be a solid-state compass for determining the compass direction of the first communication device and wherein the first communication device and the signal shielding object is turned in relation to each other about a vertical axis.

According to the disclosure, the signal shielding object is a human body. As mentioned earlier, the user can hold the first communication device in front of him, turn around on the spot, whereby the body will work as weak shield between the first and second communication devices influencing the bit error rate determined by one of the devices.

The disclosure also relates to a computer program to be installed on a handheld or wearable first communication device with a short-range wireless communication interface, which can establish a wireless link to a second handheld or wearable communication device with a short range wireless communication interface,

wherein the first communication device comprises
a processor,
a memory for storing program code,
an orientation sensing device for sensing the orientation of the first communication device, and a readout device for presenting information to a user,
which computer program is adapted to store successive link values representing the bit error rate of the wireless link between the first communication device and the second communication device as a function of the orientation of the first communication device.

The disclosure also relates to a headset with a short-range wireless communication interface, which can establish a wireless link to a second handheld or wearable communication device with a short range wireless communication interface,

which headset comprises,
a processor,
a memory for storing program code,
a speaker,
wherein the headset is adapted to store link values representing the signal strength or bit error rate of the wireless link between the headset and the second communication device as a function of the orientation headset, and that the headset via the readout device is adapted to inform the user of the specific direction, at which the second communication device is located relative to the headset.

### BRIEF DESCRIPTION OF THE DRAWINGS

Various aspects of the invention are explained in detail below with reference to the drawing illustrating a preferred embodiment of an aspect of the invention and in which

FIG. 1 is a schematic view of a smartphone and a wirelessly connected Bluetooth headset,

FIG. 2 is a diagram disclosing the most relevant elements of the headset and the smartphone, which are used when exercising an aspect of the invention,

FIG. 3 is the display of the smartphone, showing a compass card and the compass direction of the headset,

FIG. 4 is the display of the smartphone, showing a compass card and the compass direction of the headset according to another embodiment,

FIG. 5 is a schematic illustration showing how to exercise the method according to an embodiment of the invention,

FIG. 6 is a flow chart disclosing how to exercise the method according to an embodiment of.

The following reference signs are used in the figures and the following detailed description of the preferred embodiment.

| | |
|---|---|
| 1 | mobile phone |
| 2 | headset |
| 3 | solid-state compass |
| 4 | received signal strength indicator (RSSI) circuit |
| 5 | display |
| 6 | phone processor |
| 7 | Bluetooth transceiver |
| 8 | antenna |
| 9 | phone housing |
| 10 | headset transceiver |
| 11 | headset antenna |
| 12 | compass card/compass rose |
| 13 | cardinal points (intercardinal points) |
| 14 | RSSI scatter plot |
| 15 | compass direction |
| 16 | Bluetooth link |
| 17 | keys |
| 18 | mobile telephony module |
| 19 | phone microphone |
| 20 | phone speaker |
| 21 | headset microphone |
| 22 | headset speaker |
| 23 | headset housing |
| 24 | ear hook |
| 25 | user |
| 26 | right arm |
| 27 | users body |
| 28 | memory |
| 29 | headset compass |
| 30 | headset processor |
| 31 | centre of compass card |
| 32 | received signal strength indicator (RSSI) circuit |
| 33 | headset memory |

### DETAILED DISCLOSURE

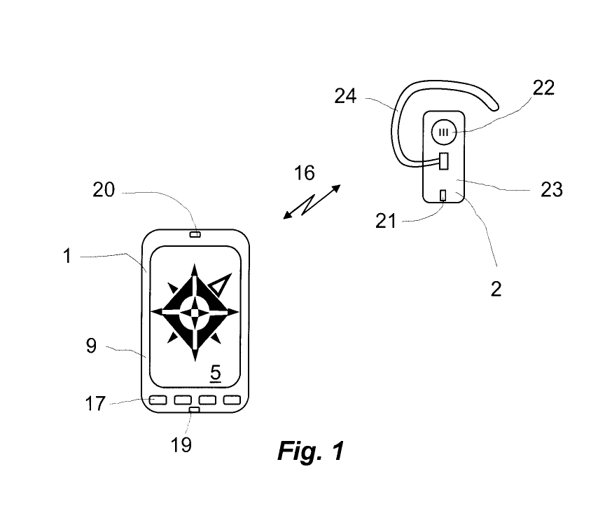

FIG. 1 shows a smartphone 1 and a headset 2, which are interconnected by a wireless Bluetooth link 16. The smartphone 1 comprises a phone housing 9, a display 5, keys 17, a microphone 19 and a speaker 20. The display 5 is large and is able to show graphics in a relatively high resolution. The headset 2 comprises a housing 23, an ear hook 24, a microphone 21 and a speaker 22. By means of the ear hook 24, the user can attach the headset 2 to his ear on make telephone conversations via the Bluetooth radio link 16.

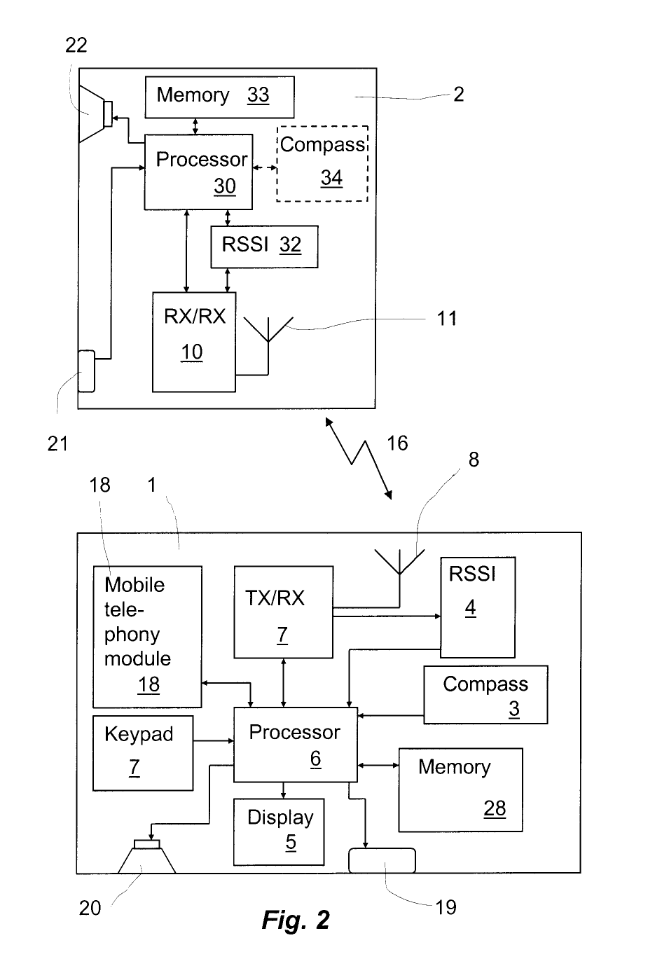

FIG. 2 discloses a diagram with the most relevant elements of the smartphone 1 and the headset 2. Besides the elements already mentioned, the smartphone 1 comprises a processor 6, a memory module 28 for storing data, applications etc, a mobile telephony module 18, a Bluetooth transceiver 7, a Bluetooth antenna 8, a received signal strength indicator (RSSI) circuit 4 and a compass 3. The compass is solid-state compass 3, which is known from several smartphones on the market today. The RSSI circuit 4 measures the power present in the Bluetooth signal received from the smartphone 1.

The headset 2 comprises a processor 30, a Bluetooth transceiver 10, a Bluetooth antenna 11, a memory module 33, and a RSSI-circuit 32. As indicated with dashed lines, the headset may also comprise a solid-state compass 34.

The diagram in FIG. 2 does not necessarily show how the different elements are physically arranged in the smartphone 1 and the headset 2. F. ex. the RSSI circuits 4, 32 could be implemented in the processors 6, 30, and the transceivers 7, 10 could be separated in transmitters and receivers. Likewise, one chip could comprise the processor 6, 30 and the memory 28, 33 in the same chip for each device 1, 2.

Before the smartphone 1 and the headset 2 can be wirelessly connected, they must be paired. This is a well-known process and will not be explained further here. After they have been paired, they can easily connect again without needing user intervention. When connected, a link 16 is established between the smartphone 1 and the headset 2, as long as they are within range of each other. The Bluetooth standard provides three classes with different maximum permitted power transmission ranges: Class 1 has an approximate range of 100 meters, Class 2 10 meters and Class 3 about 1 meter. Class 2 is mostly used with mobile phones. Thus, the typical range between the smartphone 1 and the headset 2 is approximately 10 meters. The link 16 between the two devices is normally maintained as long they are within range or the user does not actively disconnect the devices.

The headset 2 disclosed here is a small device, which is not tiring to wear and easy to keep in a pocket or the like when not in use. However, the drawback of the small size is that the headset easily gets lost and it can be connected to the smartphone while being hidden in a bag, pocket, drawer, or even on a messy desktop. Thus, the user may know that his headset is somewhere within range, but he may not know where to look in order to find it. This problem is solved by an aspect of the invention.

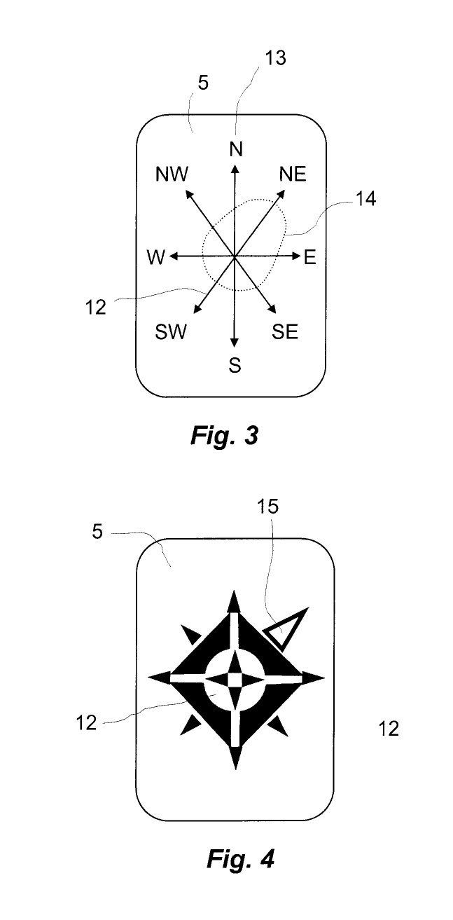

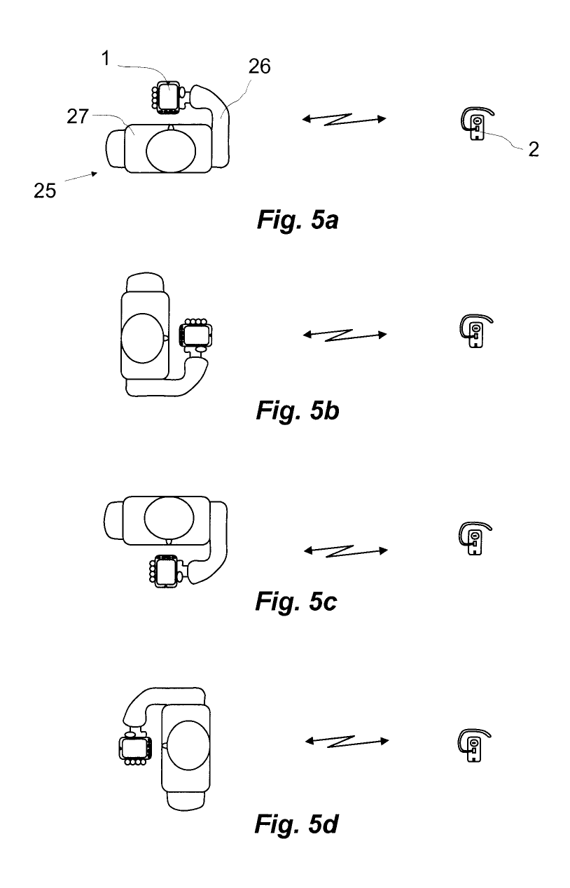

An application, which could be called “headset locator application” and which utilises the compass 3, is installed on the smartphone 1. This application can be downloaded via the telephone network, via a WLAN if the mobile phone is provided with a suitable wireless network module, or via a cable connecting the smartphone 1 with a computer. The application is programmed to determine the bit error rate (often abbreviated as BER) of the link 16 and the compass direction simultaneously or almost simultaneously and save the values together. The bit error rate is determined by the headset and the link value representing the bit error rate is transmitted to the smartphone 1. Likewise, the received signal strength (RSSI) determined by the RSSI circuit 32 of the headset can also be transmitted to the smartphone 1. The received signal strength can be used to provide further information about the quality of the radio link 16. Both BER and RSSI could be determined by the smartphone 1 too. FIGS. 3 and 4 show two different graphical user interfaces of the application. Both show a compass card 12 with the four cardinal points N (North), E (East), S (South), W (West), as well as four intercardinal points NE (Northeast), SE (Southeast), SW (Southwest) and NW (Northwest). If a user lost his headset 2 and wants to locate it, he can follow the procedure shown in FIG. 5a-d. Thus, FIG. 5 shows a user 25 from above with a body 27 and holding the smartphone 1 in his right arm 26. He holds the smartphone 1 against or close to his body 27 and turns around himself as indicated. The headset locator application will collect a number of correlated values of BER and compass direction. As the body acts as a shield for the radio waves, the BER will be lowest when the user 25 faces the position of the headset 2 and highest when the user 25 faces away from the position of the headset 2. The measured values can be shown in a BER scatter plot as shown with dots in FIG. 3. The farther the dots are from the centre of the compass card 12 the lower BER is determined. Thus, it is clear from FIG. 3 that the lowest BER was determined when the user was looking in NE direction. This means, that the user 25 should look for the headset 2 in Northeast direction.

FIG. 5 discloses a variant, where the compass direction in with the lowest BER is measured is highlighted in the compass card 12. In this example, the NE arrow is enlarged and changed colour in order to inform the user 25, that he should look in Northeast direction for the lost headset 2.

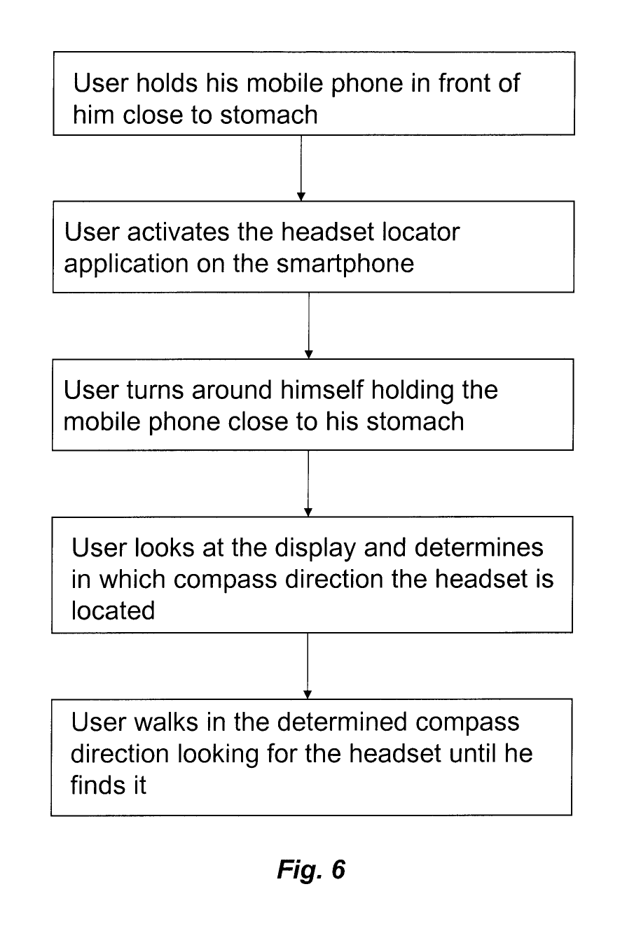

FIG. 6 is a flow chart disclosing the steps of the method according to an aspect of the invention.

The description above is only an example. Thus, the handheld or wearable device does not necessarily have to be smartphone. It could be any electronic device, which comprises a processor, a memory, a solid-state compass, and a display. Thus, a device, such as a small handheld computer with other communication means, such as a WLAN module or the like and without a telephony module could also be used.

As an orientation sensing device, only a solid-state compass 3, 34 is shown here. However, also accelerometers, gravity sensors, optical sensors could be used for determining the orientation. F. ex. a gravity sensor could be utilised for sensing an angular position in relation to horizontal. The second device is not necessarily a headset, but could be any small device, which can be wirelessly connected with the communication device. Examples of such small wireless devices could be a mouse or remote control.

A headset with built-in solid-state compass 34 could be the first communication device used for locating at second communication device, f. ex. a mobile phone. In this case the head of the user could be used as a shielding object and the headset speaker as readout device informing the user at which compass direction to look for the mobile phone.

The wireless connection does not necessarily follow the Bluetooth standard. Other radio standards, such as DECT, WLAN or WiMAX could be envisaged.

In the description above, the user turns 360°. However, this is not always necessary. In some instances, it may only be necessary for the user to turn only 180° or eve less, f. ex. if he stands close to a wall or a corner of a room.

The expression “compass direction” could be replaced by the expression “compass point”.

1. A handheld or wearable first communication device with a short-range wireless communication interface, which can establish a wireless link to a second handheld or wearable communication device with a short range wireless wireless communication interface, which first communication device comprises
a processor,
a memory for storing program code,
an orientation sensing device for sensing the orientation of the first communication device, and a readout device for presenting information to a user,
wherein
the first communication device is adapted to store link values representing the bit error rate of the wireless link between the first communication device and the second communication device as a function of the orientation of the first communication device, and that the first communication device via the readout device is adapted to inform the user of the specific direction, at which the second communication device is located relative to the first communication device.

2. A handheld or wearable first communication device according to claim 1, wherein the orientation sensing device is a solid-state compass for determining the compass direction of the first communication device.

3. A first communication device according to claim 1, wherein the readout device is an electronic display.

4. A first communication device according to claim 2, wherein the first communication device is adapted to readout information to the display showing link values in dependence of compass direction.

5. A first communication device according to claim 4, wherein the first communication device is adapted to show a compass card on the display.

6. A first communication device according to claim 5, wherein the display is adapted to show graphical representations of link values on a compass card, such the distance between the graphical representation and the centre of the compass card indicates the link value.

7. A first communication device according to claim 1, wherein the link value is determined by the second communication device and transmitted via the wireless link to the first communication device.

8. A first communication device according to claim 2, wherein the readout device is a speaker.

9. A first communication device according to claim 1, wherein the short-range wireless communication interface comprises a Bluetooth transceiver.

10. A first communication device according to claim 1, wherein it is a smartphone.

11. A first communication device according to claim 1, wherein it is a headset.

12. A method for locating the direction of a second handheld or wearable communication device in relation to a first hand held or wearable communication device, which is wirelessly connected by wireless link to the second device, which first communication device comprises
a processor,
a memory for storing program code,
an orientation sensing device for sensing the orientation of the first communication device,
a solid-state compass for determining the compass direction of the first communication device, program code for storing link values representing bit error rate of the wireless link between the first communication device and the second communication device as a function of the direction of the first communication device in relation to the second communication device,
a readout device for presenting information to a user, which method comprising the steps of
a) holding the first communication device adjacent to a signal shielding object, which shielding object partly shields the wireless signal providing the wireless link,
b) turning the first communication device and the signal shielding object in relation to each other,
c) readout information via the readout device informing a user at which direction the second communication device is located relative to the first communication device.

13. A method according to claim 12, wherein the orientation sensing device is a solid-state compass for determining the compass direction of the first communication device and wherein the first communication device and the signal shielding object is turned in relation to each other about a vertical axis.

14. A method according to claim 13, wherein the signal shielding object is a human body.

15. A computer program to be installed on a handheld or wearable first communication device with a short-range wireless communication interface, which can establish a wireless link to a second handheld or wearable communication device with a short range wireless wireless communication interface,
wherein the first communication device comprises
a processor,
a memory for storing program code,
an orientation sensing device for sensing the orientation of the first communication device, and a readout device for presenting information to a user,
which computer program is adapted to store successive link values representing the bit error rate of the wireless link between the first communication device and the second communication device as a function of the orientation of the first communication device.

16. A computer program product comprising program code means stored on a computer readable medium for performing all steps of claim 15 when said program is run on a handheld or wearable communication device.
